(19) United States
(12) Patent Application Publication
(10) Pub. No.: US 2005/0154736 A1
(43) Pub. Date: Jul. 14, 2005

(54) System and method for providing services across a network

(76) Inventors: Daniel McNeill Meikleham, Calgary (CA); Grahame John Entwistle, Calgary (CA); John Meikleham, Buckinghamshire (GB)

Correspondence Address: HESLIN ROTHENBERG FARLEY & MESITI PC, 5 COLUMBIA CIRCLE, ALBANY, NY, 12203, US

(21) Appl. No.: 11/022,318

(22) Filed: Dec. 22, 2004

Related U.S. Application Data
(60) Provisional application No. 60/530,915, filed on Dec. 22, 2003.

(51) Int. Cl. G06F 17/30

(52) U.S. Cl. 707/10

(57) ABSTRACT

The invention provides a thin-client system and method that enables users to interact with a remote server in order to eliminate local computer systems being required within private and semi-private spaces such as hotel rooms. The system enables secure and personalized short term access to high-speed services and enables an operator to deliver personalized information services to different users.

### CROSS-REFERENCE TO RELATED APPLICATIONS

This application claims the benefit of U.S. Provisional Application Ser. No. 60/530,915, filed Dec. 22, 2003, the entire disclosure of which is incorporated herein by reference.

### FIELD OF THE INVENTION

The present invention relates generally to delivering information to a user within a space utilizing a thin-client network.

### BACKGROUND OF THE INVENTION

Desktop computers having a high-speed Internet connection are often more powerful than and provide richer media experiences than mobile computing devices such as laptops. In addition, desktop computers are often significantly less expensive than mobile computing devices. As a result, the majority of Internet users access the Internet through desktop computers. This poses a problem when such users are traveling in that whether or not they have a separate mobile computing device when traveling, they can usually only access the Internet by utilizing third-party Internet access systems. Thus, while many people have embraced the use of the Internet for the delivery of information and conducting online e-commerce, many users are often frustrated by the difficulties in accessing the Internet when away from their main desktop computer, either because they must rely on third-party Internet access systems or by certain limitations such as configuring a mobile computing device to the Internet.

Most travelers require various forms of information in planning travel itineraries, making entertainment and dining decisions, sending and receiving email and otherwise receiving and accessing their usual Internet information sources. Without Internet access, some problems experienced by travelers is the need to wait for or depend on hotel staff for local information, which can often be aggravated by a language barrier. As a result, many travelers would prefer to interact with their computer in order to make travel or dining reservations, obtain specific local information and otherwise have the power to accomplish similar tasks as they would be able to accomplish from their desktop computer.

While some hotel chains have mandated that all their hotels accommodate travelers with portable computers by installing Internet network connections in the hotel rooms, even with a network connection available many guests encounter difficulties with Internet hook-up because not all laptops are “plug-and-play” due to various vintages of hardware and/or operating system installed and/or security settings that might prevent remote Internet access. Furthermore, while some hotels have hired staff with technology skills to be on-call to help guests configure their computers to connect to the room modem, such qualified staff members are not generally available 24 hours a day. Other hotels have installed wireless “hot spot” footprints in some rooms or in common areas. However, even this service is only useful to laptop carrying guests if they can configure and connect. Without in-room Internet access, guests are often forced to use the limited computers in the hotel business center, if available, or obtain internet access using Internet cafes.

Finally, even when connected to the internet, travelers are often frustrated in that location specific information is not readily available requiring the user to conduct searches from their computers to identify third-party websites that may have the information they seek.

Accordingly, there has been a need for a system for delivering high-speed Internet services to the temporary occupants or users of private or semi-private spaces without those occupants either being supplied with a computing device or bringing with them a computing device that is configured for and has access to an individual ISP account. It is therefore desirable to have a system to deliver Internet services temporarily in a secure, inexpensive, convenient and dependable manner without the occupant either carrying or receiving a computer or local processor. It is particularly desirable to further deliver value-added services to such temporary occupants or users through that system that eliminates the need for the user to conduct searches to identify particular third-party websites to provide traveller or location specific information in a cost-effective manner.

### SUMMARY OF THE INVENTION

The system of the present invention delivers high-speed Internet and value-added services to users by using a thin-client interface that enables personalized interaction with a remote server to eliminate local processors being required and allow the operators of the thin-client based service to track and charge the temporary users or an operator for such access. The remote server acts as a single point ISP and clearing house for a plurality of temporary users of a plurality of spaces providing each with secure and personalized short term access to high-speed services eliminating the need for the user to either use or configure local computing resources. Unlike X-drive or similar remote storage services, the occupant need not have any ISP account to enjoy high-speed access. The operator (e.g. a hotel chain) of the thin-client service may control content (e.g. to upsell), operational rights, and deliver personalized preferences to a range of different occupants.

In order to overcome the disadvantages of the prior art it was necessary to eliminate the need to associate the rights of access to the Internet with each individual occupant or user. Since many users would each use the high-speed system only temporarily, the ISP account rights are provided through a system operator in order to eliminate the need to configure local equipment for access, as well as to sign-up and create a new ISP account for each such user. The risk—to the system operator—of the improper use of Internet services is reduced because all access is controlled by the operator, which also permits tracking of consumption and thereby enables personalized billing based on actual usage.

In accordance with the invention, there is provided a computer system for providing at least one service to users within a space, the system comprising a user interface in the space, for permitting users to interact with the computer system; a local thin-client module operatively connected to the user interface and a network, the local thin-client module having a unique identification number for broadcasting to the network to establish an operative and secured link with a central server; wherein the central server includes software for providing at least one service to the user through the thin-client module.

In further embodiments, the central server supports a graphical user interface for a user to access a plurality of information and service resources through the thin client module, the information and service resources selected from any one of or a combination of email services, messaging, stories, dining, entertainment and travel reservation services, business services, local information, promotion and discount services, game services, internet browser services and shopping services and the user interface includes an operative combination of a monitor, keyboard, mouse, touch-screen, tablet, voice-recognition, card-swipe device or position sensing gloves. In a preferred embodiment, the central server provides different facility-specific information to a plurality of different facilities through separate graphical user interfaces, each facility having a plurality of individual thin-client modules operatively connected to the central server.

In accordance with another embodiment, the invention provides a method for an operator to provide information services to the users of a space comprising providing a user interface within said space, the user interface for permitting users to make a selection from among said services through a thin-client module operatively connected to the user interface in the space and a central server, the central server including software for delivering said services to the user interface.

In yet another embodiment, the invention provides a computer system for establishing an operative link between a plurality of distributed thin-client processors comprising: a central server having a database of unique identification numbers corresponding to registered thin-client processors, the central server for operative connection to the internet; at least one registered thin-client processor having a unique identification number for operative connection to the internet and a user interface, wherein the registered thin-client processor broadcasts the unique identification number when connected to the internet and the central server receives the unique identification number to verify that the registered thin-client processor is registered to establish an operative link between the central server and the thin-client processor and whereupon registration a user has access to space-related services hosted by the central server.

In a still further embodiment, the invention provides a computer system for providing at least one service to users within a space, the system comprising: a central operations server for managing at least one thin-client processor, the central operations server for receiving and processing input commands from each thin-client processor and directing those input commands to information application software on the central operations server for delivering information to each thin-client processor, the information being selected from information or data services including any one of or a combination of email services, messaging, stories, dining, entertainment and travel reservation services, business services, local information, promotion and discount services, game services, internet browser services and shopping services.

In yet another embodiment, the invention provides an integrated computer interface system comprising: a monitor having a display side and back side, the back side having integrated user input system connectors operatively connected to a thin-client processor, a network interface card and network interface connectors.

The accompanying drawings, which are incorporated in and constitute a part of this specification, illustrate preferred embodiments of the method, system, and apparatus according to the invention and, together with the description, serve to explain the principles of the invention.

### BRIEF DESCRIPTION OF THE DRAWINGS

The present invention, in order to be easily understood and practised, is set out in the following non-limiting examples shown in the accompanying drawings, in which:

FIG. 1 is an illustration of one embodiment of the system of the present invention applied in a hotel environment;

FIG. 2 is a block diagram showing the software elements used by system 100;

FIG. 3 is a block diagram showing the elements of the GUI of one embodiment of User Interface 101 of system 100;

FIG. 4 is a screen print of the GUI of one embodiment of User Interface 101 of system 100;

FIG. 5 is a sample screen print-out of links to an E-mail & Chat 305;

FIG. 6 is a sample screen print-out of links to Dinning & Entertainment 306;

FIG. 7 is a sample screen print-out of links to Hotel Services 307;

FIG. 8 is a sample screen print-out of links to Today's Events 308;

FIG. 9 is a sample screen print-out of links to Travel Services 310;

FIG. 10 is a sample screen print-out of links to Business Services 311;

FIG. 11 is a sample screen print-out of links to News/Weather/Sports 312;

FIG. 12 is a sample screen print-out of links to Local Attractions 313;

FIG. 13 is a sample screen print-out of links to Games & Entertainment 314;

FIG. 14 is a sample screen print-out of links to Internet Browser 316;

FIG. 15 is a sample screen print-out of links to Shopping Mall 317; and

FIG. 16 shows an sample discount coupon which may be issued to a user of the system of the present invention, to permit such user to receive a credit with third parties who are referred to such user via the system of the present invention; and,

FIG. 17 shows a schematic front and rear view of an integrated thin-client system in accordance with one embodiment of the invention.

### DETAILED DESCRIPTION OF THE PREFERRED EMBODIMENT

With reference to the drawings, a system and method for delivering services across a network is described.

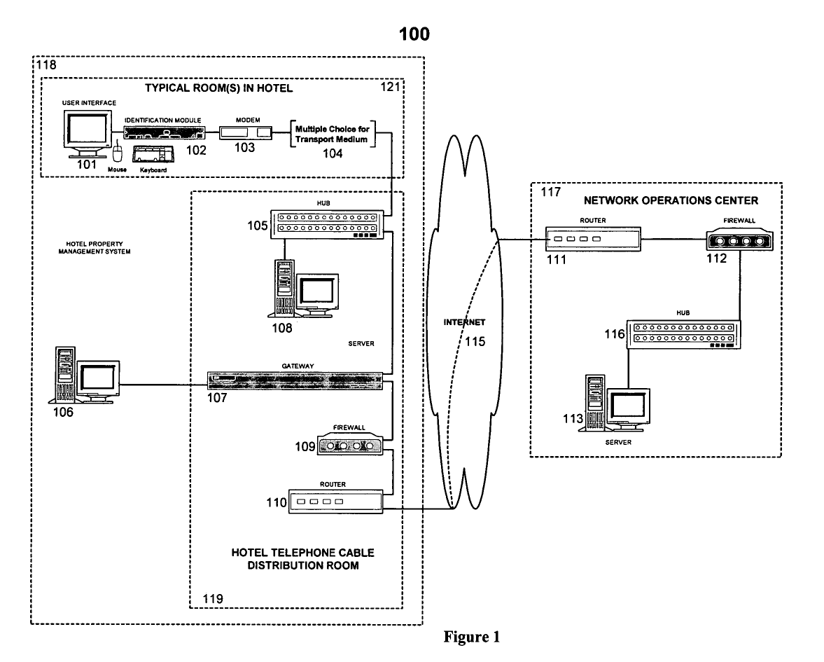

Referring to FIG. 1 there is illustrated a computer system, denoted generally as 100, for receiving input information from and delivering information to the occupant or user of a space 121 without the need of a computing device in space 121. In the context of this application a computing device is a device that has standalone computing capabilities meaning that the device has the capabilities of standalone application processing. According to a preferred embodiment of the system, space 121 is one of many similarly equipped rooms or booths in a private or semi-private location 118 such as a hotel, campus, marina, waiting room, restaurant, court house, bus station, ship, airport or train having access to the Internet 115 and optionally having a communications room 119 or pre-existing management system 106. Within each space 121 there is provided a user interface 101, which includes any suitable technology by which a user may query and instruct system 100. For example, user interface 101 may include or be assembled from, but is not limited to an operative combination of a touch screen, an LCD monitor with keyboard and mouse, speakers, a microphone and voice recognition technology, a tablet and handwriting recognition technology, gaming headsets and position sensing gloves, credit, debit and smart card swipe devices and other I/O technologies depending upon the particular services being provided to space 121 via system 100.

User interface 101 is connected to an identification module 102, being any device (for example, a stateless thin-client device, containing an identifying address, such as a Wyse Winterm 1200 (San Jose, Calif.)) that operates as a node on a network and provides reliable technology for uniquely identifying the particular installation of user interface 101 in each space 121. Identification module 102 transfers digital content, data, user instructions, message control instructions, and other information to and from its user interface 101 via any suitable modem 103 (e.g. a DSL modem), over any suitable network medium 104 (for example, a DSL telephone line, twisted pair, coaxial cable, wireless radio or infrared) connected to any suitable distribution hub 105 (for example, an Ethernet hub) connected to any suitable authentication gateway 107 to control (for example using a MAC address of identification module 102) unauthorized access to system 100. In the context of this application, a thin-client device has no standalone computing capability beyond accepting information from an input device such as a keyboard or mouse, directing that information to a central processor and receiving information from the central processor for output to an output device.

A person of skill in electronic communications will understand that distribution hub 105 and authentication gateway 107 can serve several spaces 121 respecting which usage or consumption information may be provided to pre-existing record systems such as property management system 106 for billing and other uses. Similarly, it will be apparent that signals passing through Identification Module 102 may be transmitted on “Remote Authentication Dial In User Service” (RADIUS) protocol as specified by the Internet Engineering Task Force (IETF) working group for Configuration, Authentication and Accounting, and Dynamic Host Configuration Protocol (DHCP) for automating the configuration of nodes that use TCP/IP.

According to one embodiment of system 100, gateway 107 is connected through distribution hub 105 to a local server 108 running a network operating system (e.g. Microsoft 2003) deploying a thin-client architecture (e.g. Citrix®) together with suitable application software. Thin-client applications may use Independent Computing Architecture (ICA) to separate Identification Module 102 from the application's logic that resides in and executes entirely on local server 108. It is the ICA that enables the application's interface, message control instructions, keystrokes and mouse movements, and other information to be transmitted via Identification Module 102 for interaction with the user through User Interface 101, in accordance with standard network protocols (e.g. TCP/IP) over network medium 104. Using the thin-client ICA model to serve several spaces 121 consumes a fraction of the network bandwidth of the client/server model and efficiently centralizes all system, application and user management on local server 108 while a number of users each operates his or her user interface 101 to interact with several applications as if they were running on his or her identification module 102.

According to one embodiment of system 100, suitable for installation in buildings suffering bandwidth limitations typically arising from older wiring, if a user selects a file from a remote source reached through server 108 over Internet 115, that requested file is delivered to local server 108 which then sends only appropriate portions to space 121 in order to eliminate the need for substantial data storage located in or a computer dedicated to space 121. However, as computer power increases and bandwidth restrictions are eliminated in newer buildings in which high-speed communication has been integrated, it is contemplated that local server 108 may be eliminated and a powerful single server thin-client model based on control server 113 delivering all information to user interface 101 will be preferred. For example, a large hotel chain may choose to implement a super computer server with substantially wireless transfer means based on bi-directional satellite communication with each of the hotels in its chain. In either embodiment of system 100, to ensure appropriate levels of privacy for each user, apart from any ROM, buffer, or cache memory that permits smooth and fast operation, neither user interface 101 nor identification module 102 contain any or sufficient data storage to leave residual information accessible from within space 121 by a subsequent occupant or user thereof.

According to the foregoing two server model, local server 108 is preferably protected by any suitable firewall 109 in turn connected to any suitable Internet access router 110, permitting local server 108 to safely communicate over the Internet 115 with the Network Operations Center (NOC) 117 of system 100, anywhere in the world. At NOC 117, a control server 113 is similarly protected by any suitable firewall 112 through which all communications from the Internet 115 and router 111 must pass before they reach control server 113. According to an alternate embodiment, system 100 may include a distribution hub 116 that permits control server 113 to communicate with other systems as required for a variety of purposes. Control server 113 typically includes network management and operations center software to remotely manage local server 108 and monitor each identification module 102 installed at location 118. The governance of system 100 may be distributed between local server 108 and control server 113 according to the competence of the operators at each site and the amount of information moving over network medium 104.

According to a preferred embodiment of system 100 installed for use by a hotel chain, control server 113 provides a convenient way to track royalty or usage charges accumulating across a plurality of locations 118 each having a local server 108. Further, where digital content, in respect of which copyright payments incur, are being served to users taking advantage of user interface 101, the tracking of charges payable (e.g. to SOCAN) by the legal entity responsible for the hotel chain is more easily accomplished and monitored.

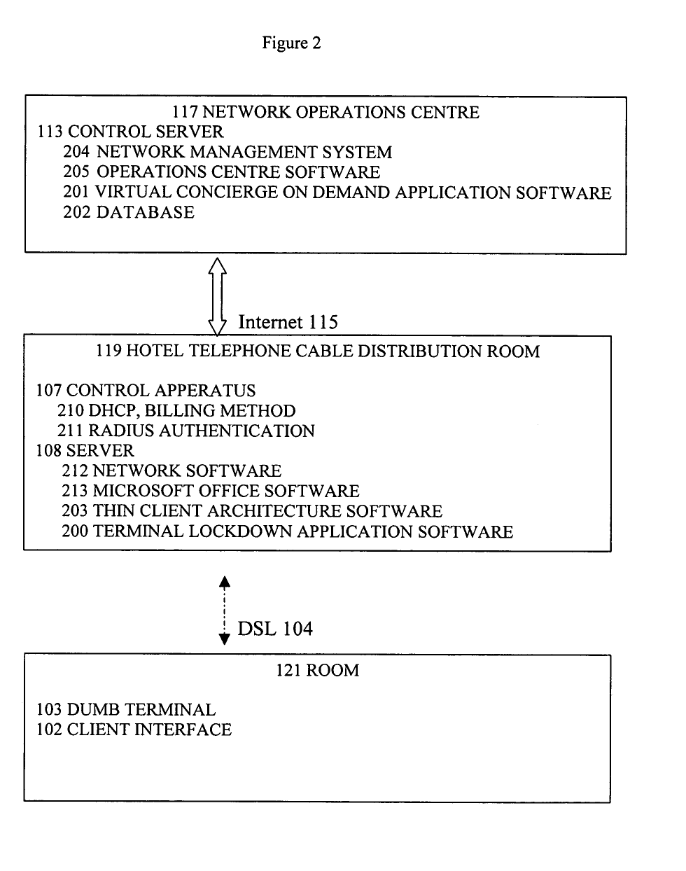

Referring to FIG. 2, at NOC 117 control server 113 contains: operations centre software 205, network management software 204, database software 202 (e.g. MySQL), and Virtual Concierge on Demand “VCoD” application software 201 (described in more detail later), as well as other web-based applications, together allowing communication between control server 113 remote from local server 108 to deliver high-speed internet access to each user interface 101 via the corresponding identification module 102. Local server 108 in turn contains: thin-client architecture software 203, network software 212, suitable components of various application software 213 (e.g. Microsoft Office) and other web-based applications. According to a preferred embodiment of system 100, terminal lockdown software 200 is also included on local server 108 to ensure that occupants cannot tamper with settings or otherwise abuse their access. Gateway 107 contains: tracking software 210 (e.g. DHCP) to manage and automate the assignment of IP addresses, and authentication software 211 (e.g. RADIUS) for controlling access to Internet 115.

A person of skill in networking would understand that “RADIUS” authentication may be used for centralizing network authentication of remote access from a plurality of user interfaces 101. Radius is client-server software (including an authentication and authorization access protocol) that can reside in gateway 107 and authenticate connections to a network device such as router 110 or router 111, which pass user information to gateway 107 that returns a response used to grant or deny access. Gateway 107 may be any suitable server appliance that provides a range of advanced IP services and user-level security required in networks accessing the Internet. Supporting IP address management (DHCP), multiple billing options such as credit card payments and or redirection, authorization, authentication and accounting via management system 106.

The system and method of the present invention have many uses, for example, to provide a flexible, low-cost solution for hotels to supply on demand, in-room, high-speed Internet service without requiring guests to travel with a computer or to provide computers within the hotel room. The need for computer configuration is also eliminated. The use in-room of user interface 101 and identification module 102—having no disc or other moving parts—also means no equipment needs to be switched off each night, reducing hotel electrical power consumption when compared to the use of standard computer systems. Using popular Microsoft 2003 software 212 on local sever 108 permits service in a familiar Windows® environment. Citrix® Thin Client Architecture software 203 eliminates the need for software to be stored in Identification Module 102. Business application software 213 (e.g. the Microsoft Office Suite) on local server 108 permits occupants to access files that they may save on local server 108, e-mail, or send to print via hotel management system 106. Although the need to have a computer in space 121 is eliminated, the use of authentication software 211 (e.g. RADIUS) and tracking software 210 (e.g. DHCP) in gateway 107 still permits guests who bring a computer to enjoy access to Internet 115 using a pre-existing ISP account upon configuration.

According to one embodiment of the system of the present invention, terminal lockdown software 200 is installed on local server 108 (to prevent previous occupants leaving “garbage” behind) such that the exchange between each Identification Module 102 and local server 108 is refreshed frequently (e.g. every two minutes) in preparation for the next user to use system 100.

VCoD application software 201 may be written in PHP for web development embedded into HTML and HTML coded format language used for creating hypertext documents on the World Wide Web.

Network management software 204 allows administrators at NOC 117 to efficiently insert and update database 202 using Structured Query Language (SQL). Database 202 is an organized collection of information that control server 113 uses to select and display portal content. VCoD application software 201 on control server 113 at remote NOC 117 makes concierge information available around the clock in space 121. Advantageously, this new method of delivering common information saves both the guest and the hotel staff time by eliminating the need for guests to line up at the front desk for concierge services and facilitates business-to-consumer (B2C) commerce.

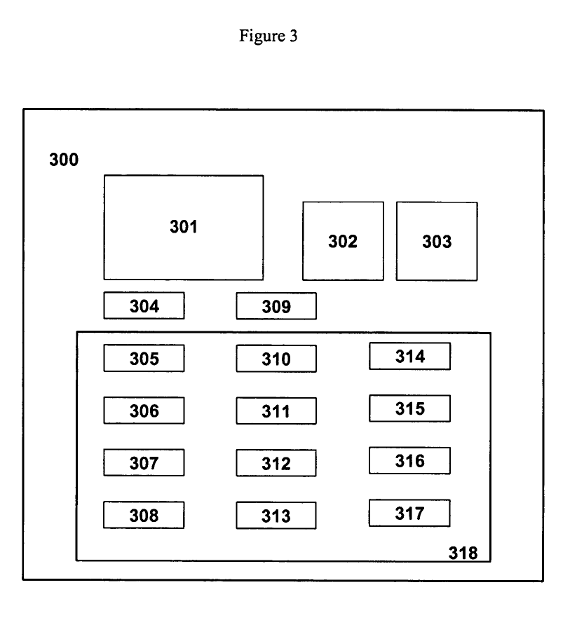

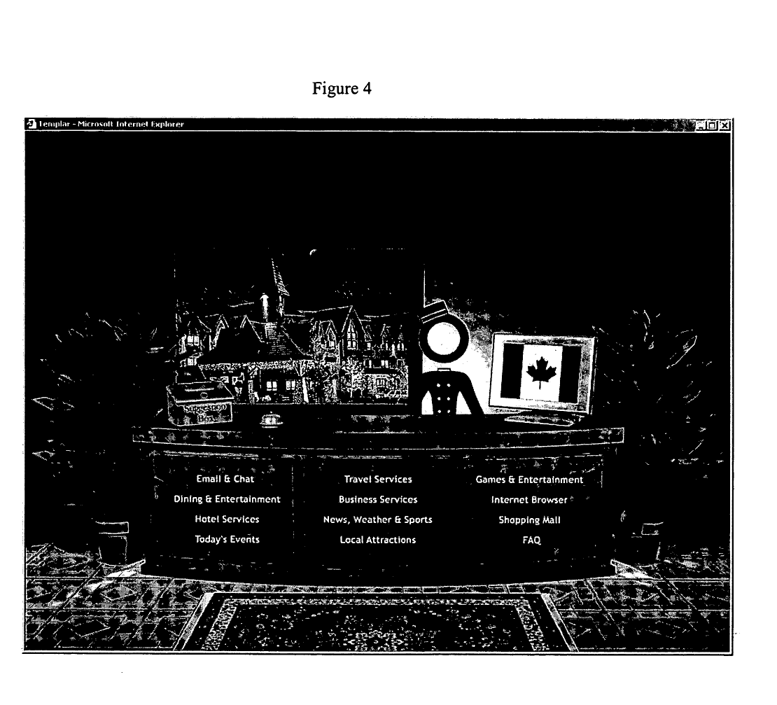

Referring to FIGS. 3 and 4, according to the hotel embodiment of the present invention, system 100 offers service to the users (not shown) of space 121 through a graphical user interface GUI 300 having several icons and active zones for accessing a portal that is the output of VCoD application software 201 using data stored on control server 113.

e-Billboard 301 is used to display information in a context specific manner. For example, when User Interface 101 is not being used in connection with any of the icons or active zones e-Billboard 301 may flash or scroll images that relate to the individual hotel or to the entire chain of hotels for which it provides service. Informative images of the dining room, sauna & pool, tennis courts and other internal facilities may be used to attract the attention of the users to system 100. Promotional images of the beaches and mountains adjacent sibling facilities may also be displayed to attract attention to other hotels in a chain installation. Scrolling inducements and instructions may be displayed in connection with mouse movement or screen touches being detected in order to facilitate inexperienced occupants commencing use of system 100. As the mouse or other position detecting technology used as part of user interface 101 intersects the various icons or active zones within GUI 300, e-Billboard 301 may display context sensitive explanations or instructions that alert occupants respecting what they may access through or how to use system 100. It is also contemplated that the scenery (e.g. the bushes, lighting, floor coverings, and other elements of decor) displayed in GUI 300 may match the actual lobby of the hotel and change according to season.

According to one embodiment of the present invention, GUI 300 will be enabled to promote local suppliers cross-selling in exchange for a commission. For example a box of chocolates or a vase of roses may appear on counter 319 as active zones that trigger a change of content on e-Billboard 301. As the mouse passes over the roses information respecting a local florist from whom such roses may be purchased appears, then as the mouse moves over the chocolates information respecting a local candy shop appears. Clicking on the roses or the chocolates may bring up an order form that leads to selection, purchasing and delivery options directed on a priority basis to a local supplier who pays a monthly commission to the operator of system 100.

Virtual bell-boy 302 is an animated attendant the purpose of which is to create for occupants a user-friendly and engaging interactive experience whenever they use system 100. According to a preferred embodiment of the present invention, audio capability included in system 100 permits bell-boy 302 to speak to the occupants in a pleasant voice and the language of their choosing. Voice recognition technology makes it possible to implement embodiments of system 100 in which bell-boy 302 can also understand basic queries posed by occupants. Even in non-speaking, non-listening embodiments of system 100, bell-boy 302 can promote usage by context sensitive movements intended to attract interest by the occupants of space 121. And, when the occupants require assistance they can click on the body of the virtual bell-boy 302 to immediately summon a human bell-boy to move luggage, order up a taxi, retrieve a parked car from the valet, arrange for dry cleaning, or any other service. It is contemplated that virtual bell-boy 302 may be selected by the occupants to or automatically match their booking profile and generated for display as a figure of any sex, race, height, weight, eye or hair colour, et cetera.

In a related manner, Help Bell 305 is linked to hotel management system 106 and serves the purpose of raising the immediate attention of hotel staff. Whereas the bell-boy 302 accesses an array of ordinary services the requests for which are fairly recorded in a queue (virtual lineup) on a reasonable response time basis—the Help Bell 305 alerts hotel staff to the fact that a guest is in need of immediate (possibly an emergency) assistance or becoming impatient waiting for ordinary services.

It is contemplated that there may also be an icon for a voice over IP phone on desktop 319, clicking which would link to a room, local, national or international phone directory permitting occupants to use system 100 to initiate telephone calls either through the User Interface 101 or a phone set in space 121. Further the phone on desktop 319 could access a Chat Room service (e.g. Yahoo Messenger) permitting individual guests to share information that would make it easier to meet other guests with similar interests—or to permit a group of guests to privately real-time conference between rooms. And, hotel staff could be contacted to access database 202 to help individual guests find specific information and then send the required information directly to a User Interface 101 where occupants can view it and then proceed to surf and find more information through system 100.

Counter display 303 permits occupants to change the language used throughout GUI 300, including Directory 318 comprising any number of icons or active zones on the front of the concierge desk. When not in use counter display 303 exhibits a different flag every few seconds suggesting the languages available.

Suggestion Box 304 provides means for gathering guest satisfaction survey information electronically. Clicking Suggestion Box 304 generates a message that is pre-addressed to a supervisor (e.g. the Hotel Manager or the Administrator of NOC 117) and may be stored in the database 202 for future review or reprocessing. A person of skill in the art would understand that an intermediate form may be used to direct the message by any suitable electronic means to individuals or groups of recipients who may be selected on such form. Similarly the organizers of business or other conferences may “rent” Suggestion Box 304 for short term use during specific events making it easier for conference participants to fill out feedback forms after a full day of educational or other work. Advantageously, Suggestion Box 304 rental permits organizers to enjoy substantial cost and time efficiencies as compared to printing, distributing, gathering, and consolidating the information from the feedback or other (often wasted) forms used in conferences attended by large groups.

Directory 318 (shown in FIGS. 3 and 4 having only 12 items) lists, on the front of the virtual concierge desk, a variety of “concierge like” information including services. Directory 318 may be displayed as a panel of buttons that link to various sources of different kinds of information, for example but not in limitation: E-mail & Chat 306; Dining & Entertainment 307; Hotel Services 308; Today's Events 309; Travel Services 310; Business Services 311; News/Weather/Sports 312; Local Attractions 313; Games & Entertainment 314; Internet Browser 315; Shopping Mall 316; and FAQ 317. Some of the foregoing sources may be internal to the hotel, others may be controlled or repacked versions of associate suppliers, some may be free and entirely public, but system 100 is enabled so as to easily permit the tracking of cross-selling and up-selling for commission calculation and distribution purposes.

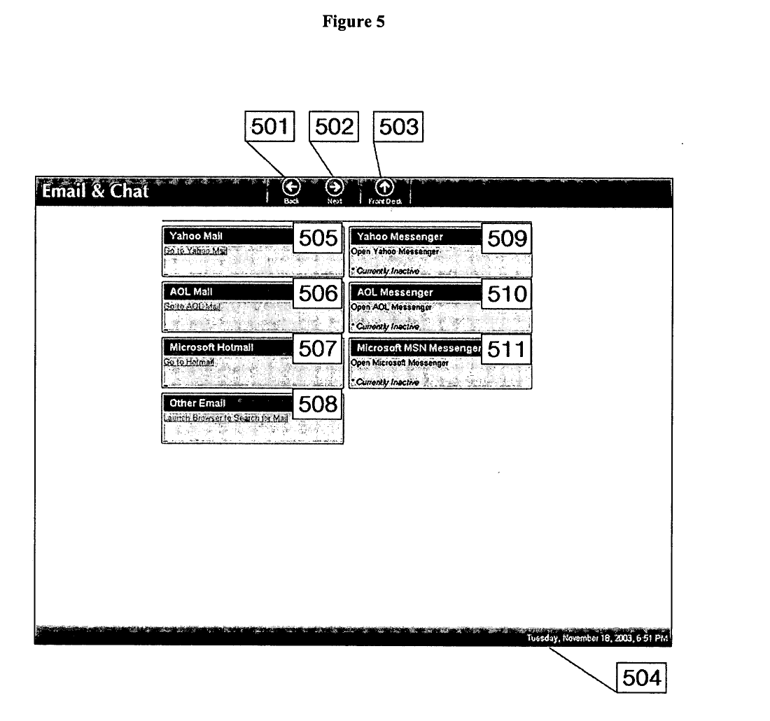

Referring to FIG. 5, the E-mail & Chat icon 306, of FIGS. 3 and 4 links to a directory 500 of communication services including but not limited to e-mail and chat technologies. For example, Yahoo 505, AOL 506, Hotmail 507, browser 508 (to access e-mail services not expressly listed), Yahoo Messenger 509, AOL Messenger 510, and MSN Messenger 511 allow users to log-on to existing accounts or create new accounts. A person of skill in portal development will understand that elements of GUI 300 will be common from screen to screen, for example Back 501, Next 502, Front Desk 503, and Date Time 504 will typically be accessible on the different pages displayed via the portal of system 100.

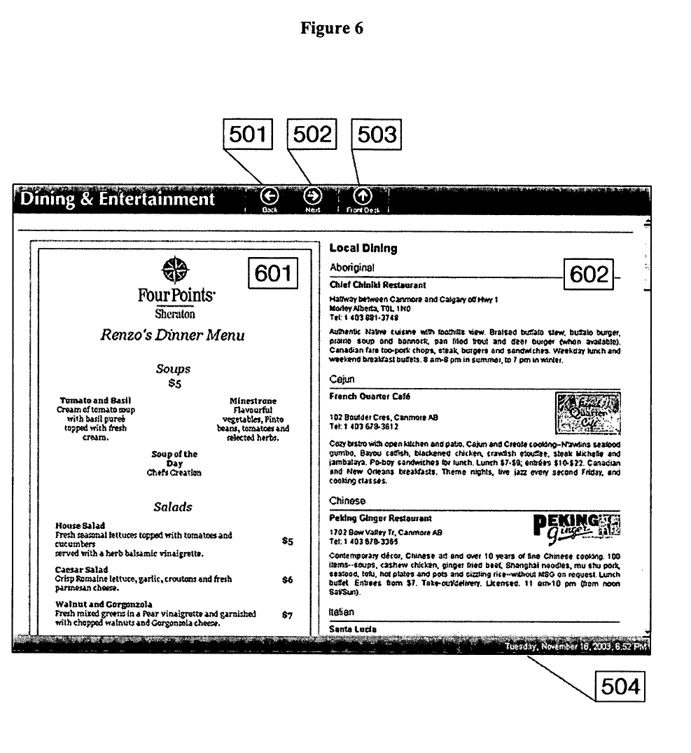

Similarly, referring to FIG. 6, the Dining & Entertainment icon 307 links to hotel restaurant menu 601 and list of local restaurants 602. According to one embodiment, the list of local restaurants 602 may be objectively based on remotely generated content that is continually updated or be subjectively controlled as part of a cross-selling agreement and accessed from a more static database 202 that is monitored and maintained by data entry clerks at NOC 117.

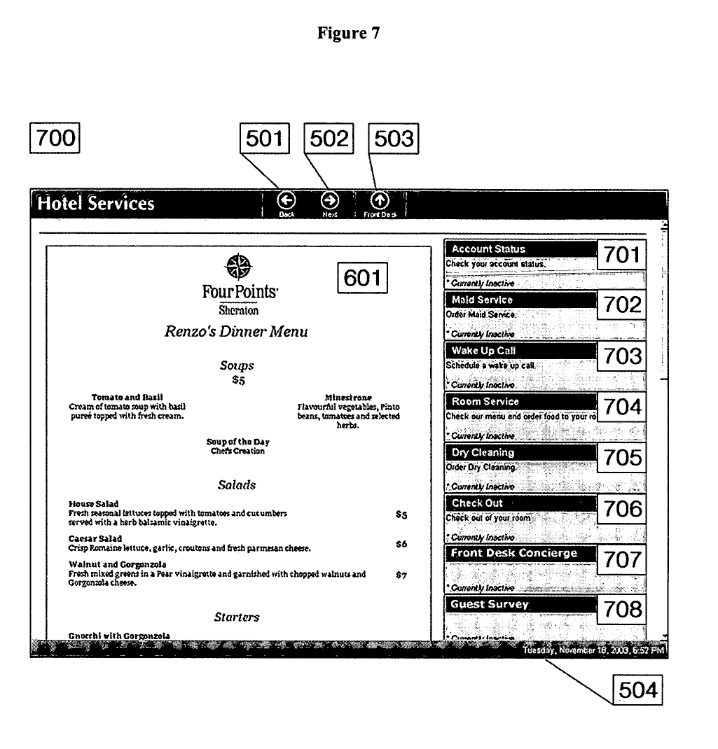

Similarly, referring to FIG. 7, the Hotel Service icon 308 links to a page 700 in association with which Identification Module 102 connects to management system 106 to permit virtual access to services (e.g. see icons 701-707) normally available in a hotel. According to one embodiment, by example a front desk employee using a chat room may be linked to database 202 to assist a guest find specific information or locations nearby, display on user interface 101 the history of any previous visit, and supply an update of what is new since the last visit. Database 202 may be interactive, first asking what help the user needs, then using appropriate applications to comply with the request, and then sending the results for display on User Interface 101. Electronic guest survey 708 addresses what to do and see at specific destinations, which is stored and processed for access in an appropriate form by subsequent guests. It is contemplated that, with appropriate consent (and complying with Privacy Legislation), guest activities may be tracked for a variety of value-added uses.

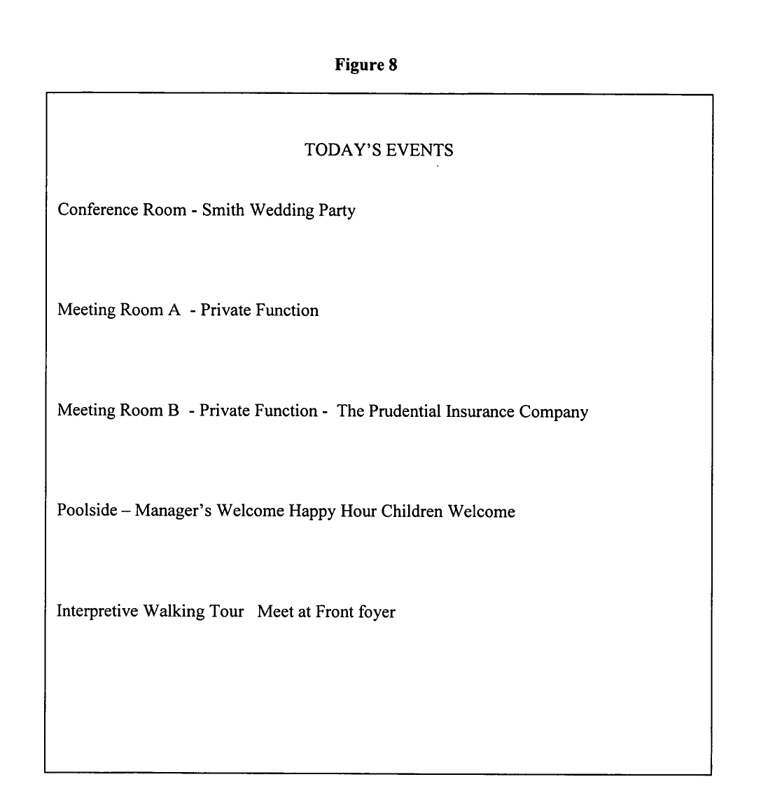

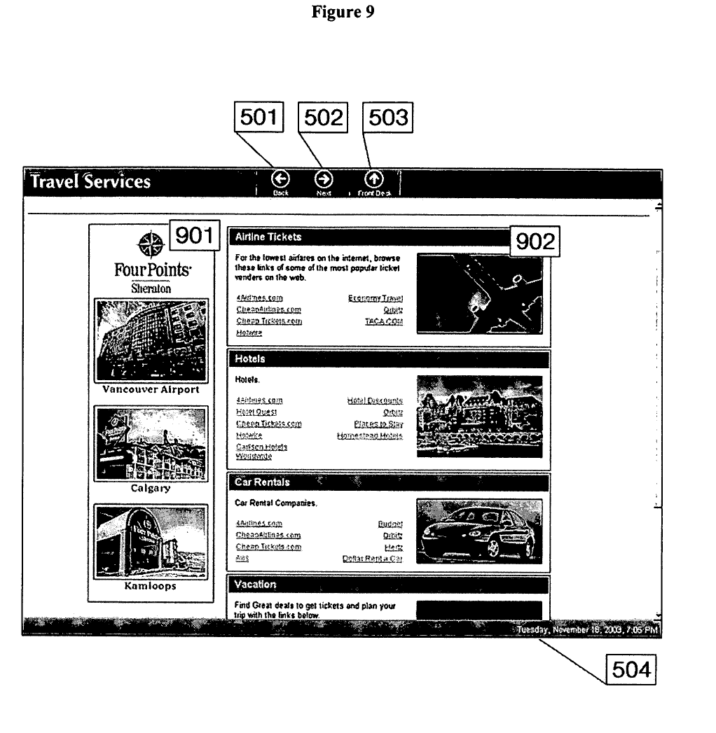

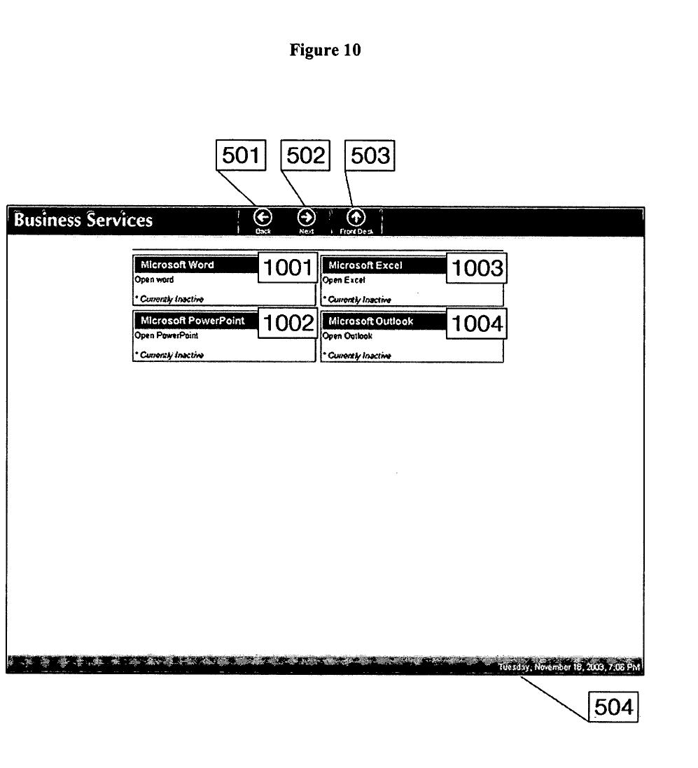

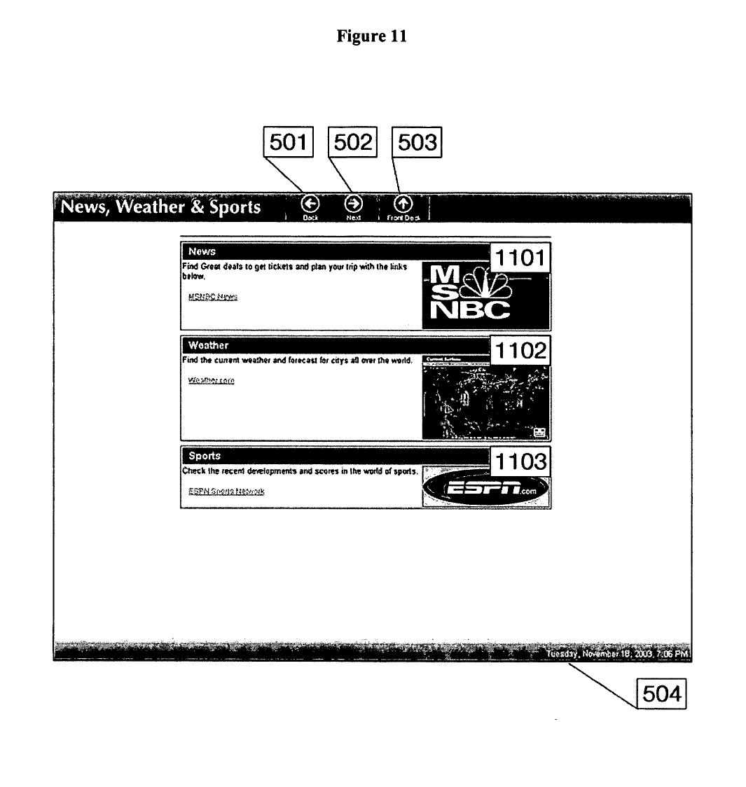

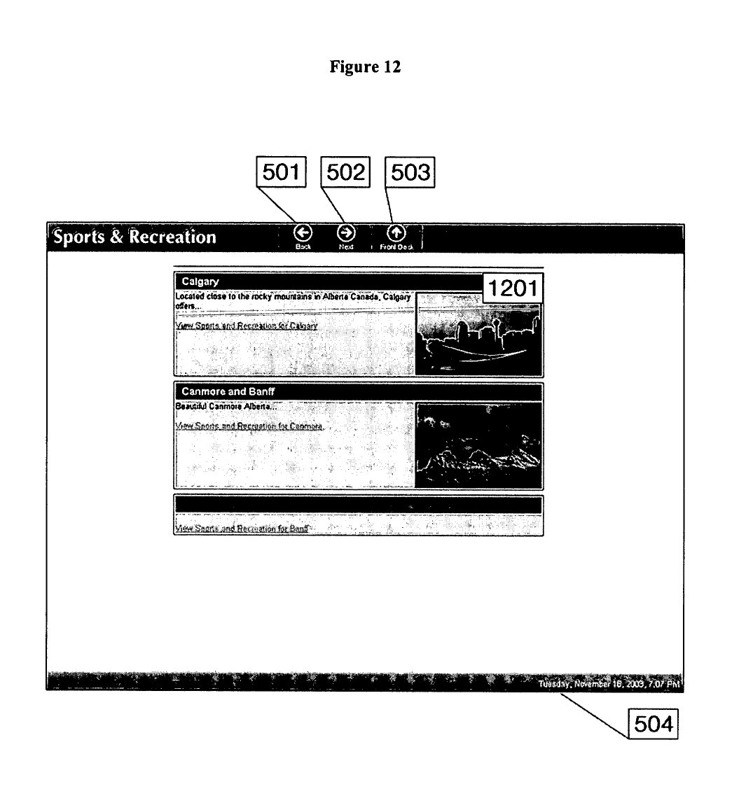

Similarly, referring to FIG. 8, the today's events icon 309 links to concierge information of a kind that is commonly created or maintained and updated daily by hotel employees. And, referring to FIG. 9, the Travel Services icon 310 links to travel related websites 902 (e.g. Cheap Tickets.com) or the web-sites of similar hotels in a geographical region or along the route to a destination. Similarly, referring to FIG. 10, the Business Services icon 311 links to business related services and applications such as the Microsoft Office Suite (see 1001-1004) to send and receive faxes or send a file to print at management system 106. And, referring to FIG. 11, the News icon 312 links to popular websites such as: MSNBC News 1101, Weather.com 1102, and ESPN News 1103 that may be launched in a new instance of any suitable browser. Similarly, referring to FIG. 12, the local attractions icon 313 links to various web-sites that promote and market products, services, articles, travel, entertainment and leisure activities of the hotel and local merchants.

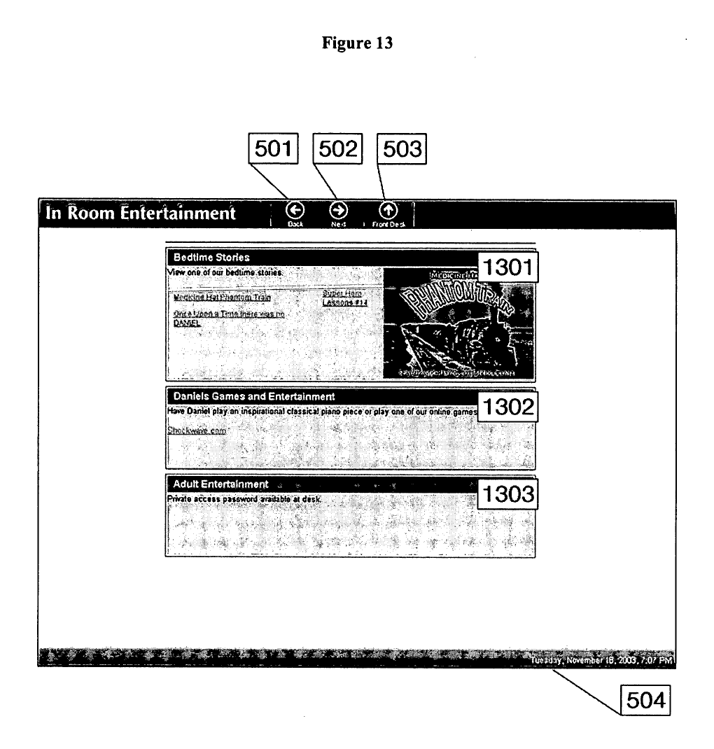

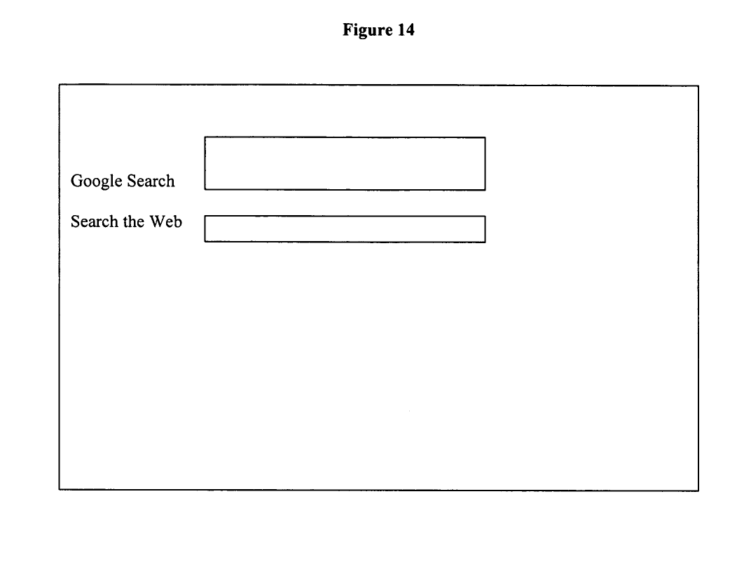

Similarly, referring to FIG. 13, the entertainment icon 314 may link to libraries of bedtime stories 1301, games 1302, and adult entertainment 1303, which can be initiated on demand. Folklore stories may be indigenous to a particular region for narration by bell-boy 302 or similar animated character in any suitable setting (e.g. sitting by a camp-fire). Stories of local legends (e.g. Mountain Men, Native Indian, Ghost Stories, Train Disasters, Mine Disasters, Pirates, Bigfoot, Shipwrecks) provide historical background. Access to online games through system 100 permits playing in real time other persons in the same hotel or anywhere in the world via the Internet 115. Similarly, referring to FIG. 14, the Internet Browser icon 315 links to a selection of search facilities, for example GOOGLE.com.

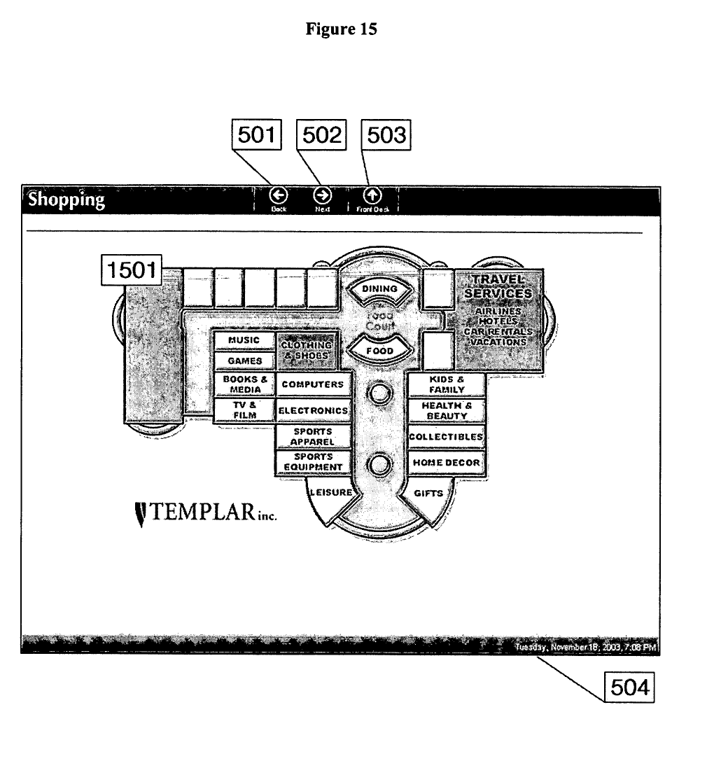

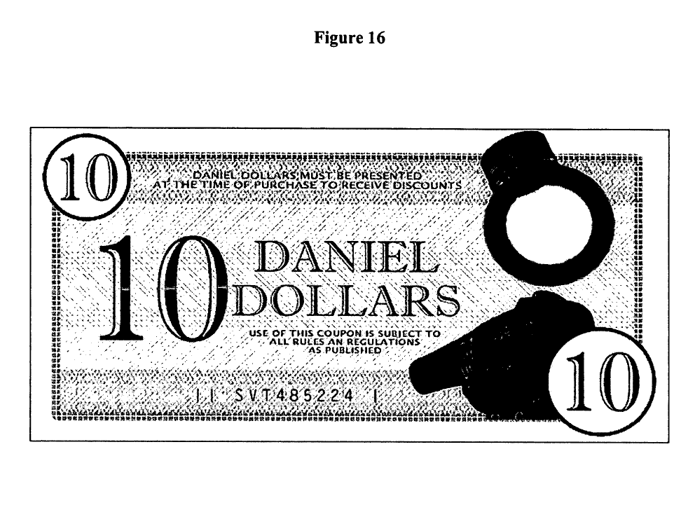

Similarly, referring to FIG. 15, the Shopping Mall icon 316 links to a shopping-mall floor plan 1501 displaying stores each linked directly to local merchants or displaying phone numbers making it easy to locate goods or services. For example, a salesman forgets the overhead projector plug-in, or a travelling executive invited by her prospective client to an outdoor Bar-be-cue on his Western Ranch didn't pack casual clothing, or it's secretaries week and the boss is on the road but wants to send flowers. A data entry clerk can add, remove, or update a shop in floor plan 1501 by logging into network management system software 204 and entering the relevant information without having to modify any HTML code, develop any server side scripting, or input data directly into the database. And, referring to FIG. 16, Virtual Discount Coupon 1601 can be purchased by adding to the hotel room account for redemption by hotel staff or in connection with purchases at stores accessed using Shopping Mall icon 316.

A preferred embodiment of this invention anonymously tracks service usage and creates reports that allow the developers to analyse concierge service popularity. This provides developers information necessary to improve functionality and presentation as well as develop content delivery strategies to maximize customer service, user friendliness and profitability. Account management software allows users who choose to register as members to save information on control server 113. Members have the ability to customize the Virtual Concierge portal, and access services only available to registered members, such as scheduling and trip planning. Universities and Colleges may supply Internet services to students in a similar manner for similar reasons. Marinas and resorts around the world may use an embodiment of the system of the present invention—based on point to multipoint 802.1 lb wireless networking—to provide high-speed digital services to boats and other RVs while temporarily docked and for a limited range while mobile but still within a “hot spot” created for such facilities.

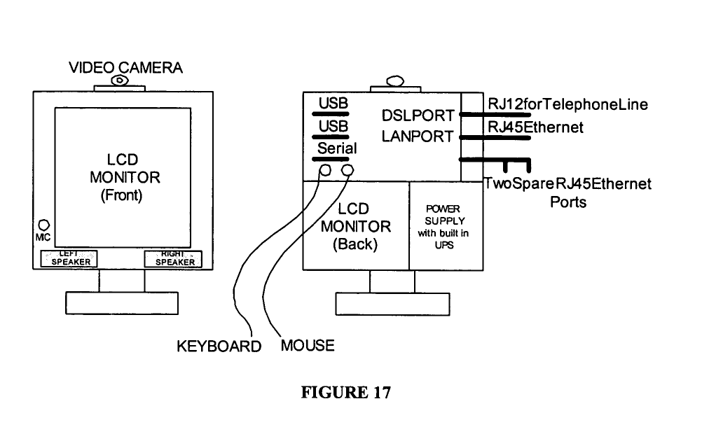

With reference to FIG. 17, an embodiment of the space hardware is described in which the user interface, identification module 102 and modem 103 are integrated into a single integrated unit for convenience of installation in both private and semi-private spaces. In this embodiment, an identification module 102/modem 103 is integrated to the back of an LCD monitor with appropriate connectors being provided to enable connection to the internet and to input devices (for example, keyboard, mouse and/or video camera). In addition, the integrated unit will preferably include a built-in power supply that will preferably include an uninterrupted power supply to enable the system to operate in the event of a power failure to the space. This embodiment provides advantages to the operator of the space in terms of ease of installation by the elimination of visible wires between the user interface 101, identification module 102 and modem 103 as decreasing the risk of inadvertent disconnection of wires. In various embodiments of the integrated unit, the mouse and keyboard (if utilized) may be wireless and the user interface 101 may be provided with a video camera.

Although the disclosure describes and illustrates various embodiments of the invention, it is to be understood that the invention is not limited to these particular embodiments. Many variations and modifications will now occur to those skilled in the art of communication. For full definition of the scope of the invention, reference is to be made to the appended claims.

1. A computer system for providing at least one service to users within a space, the system comprising:
a user interface in the space, for permitting users to interact with the computer system;
a local thin-client module operatively connected to the user interface and a network, the local thin-client module having a unique identification number for broadcasting to the network to establish an operative and secured link with a central server;
wherein the central server includes software for providing at least one service to the user through the thin-client module.

2. The system as in claim 1 wherein the central server supports a graphical user interface for a user to access a plurality of information and service resources through the thin client module, the information and service resources selected from any one of or a combination of email services, messaging, stories, dining, entertainment and travel reservation services, business services, local information, promotion and discount services, game services, internet browser services and shopping services.

3. The system as claimed in claim 1 wherein the user interface includes an operative combination of a monitor, keyboard, mouse, touch-screen, tablet, voice-recognition, card-swipe device or position sensing gloves.

4. The system as claimed in claim 1 wherein the thin-client module is a stateless device that operates as a node on a network and contains a unique MAC address.

5. The system as in claim 2 wherein the central server provides different facility-specific information to a plurality of different facilities through separate graphical user interfaces, each facility having a plurality of individual thin-client modules operatively connected to the central server.

6. The system as in claim 1 wherein the space is a room in a hotel.

7. The system as claimed in claim 6 wherein the at least one service is selected from information or data services including any one of or a combination of email services, messaging, stories, dining, entertainment and travel reservation services, business services, local information, promotion and discount services, game services, internet browser services and shopping services.

8. A method for an operator to provide information services to the users of a space comprising providing a user interface within said space, the user interface for permitting users to make a selection from among said services through a thin-client module operatively connected to the user interface in the space and a central server, the central server including software for delivering said services to the user interface.

9. A computer system for establishing an operative link between a plurality of distributed thin-client processors comprising:
a central server having a database of unique identification numbers corresponding to registered thin-client processors, the central server for operative connection to the internet;
at least one registered thin-client processor having a unique identification number for operative connection to the internet and a user interface,
wherein the registered thin-client processor broadcasts the unique identification number when connected to the internet and the central server receives the unique identification number to verify that the registered thin-client processor is registered to establish an operative link between the central server and the thin-client processor and whereupon registration a user has access to space-related services hosted by the central server.

10. A computer system for providing at least one service to users within a space, the system comprising:
a central operations server for managing at least one thin-client processor, the central operations server for receiving and processing input commands from each thin-client processor and directing those input commands to information application software on the central operations server for delivering information to each thin-client processor, the information being selected from information or data services including any one of or a combination of email services, messaging, stories, dining, entertainment and travel reservation services, business services, local information, promotion and discount services, game services, internet browser services and shopping services.

11. An integrated computer interface system comprising:
a monitor having a display side and back side, the back side having integrated user input system connectors operatively connected to a thin-client processor,
a network interface card and network interface connectors.

12. An integrated computer interface system as in claim 11 wherein the integrated computer interface system further comprises an integrated uninterrupted power supply operatively connected to the thin client processor.

13. An integrated computer interface system as in claim 12 wherein the monitor is an LCD monitor.
